(19) United States
(12) Patent Application Publication
(10) Pub. No.: US 2014/0231705 A1
(43) Pub. Date: Aug. 21, 2014

(54) AQUEOUS POLYMER COMPOSITION FOR REMOVING DUST

(71) Applicant: SAMSUNG FINE CHEMICALS CO., LTD, Ulsan (KR)

(72) Inventors: Sung Hoon Kim, Ulsan (KR); Nak Woon Choi, Daejeon (KR); Wook Hwan Noh, Daejeon (KR)

(73) Assignee: SAMSUNG FINE CHEMICALS CO., LTD, Ulsan (KR)

(21) Appl. No.: 14/347,762

(22) PCT Filed: Nov. 9, 2012
(86) PCT No.: PCT/KR2012/009452

§ 371 Date: Mar. 27, 2014

(30) Foreign Application Priority Data
Nov. 10, 2011 (KR) 10-2011-0117027

(51) Int. Cl. C09K 3/22

(52) U.S. Cl. CPC C09K 3/22
USPC 252/88.1

(57) ABSTRACT

The present invention relates to an aqueous polymer composition for removing dust. The composition comprises a cellulose ether and water, and the cellulose ether can be dissolved in water to produce a dust removing cellulose ether aqueous solution which then exhibits a long-term dust removing effect due to the water-retention properties and the film forming properties of the cellulose ether.

### TECHNICAL FIELD

The present invention relates to an aqueous polymer composition for removing dust, and more particularly, to an aqueous polymer composition for removing dust to be sprayed for the purpose of remarkably reducing an amount of fine dust scattered in routes of trucks in construction sites and engineering work places, coal pick-up places, and open top rail cars.

### BACKGROUND ART

In construction sites, coal pick-up places, and the like, a large quantity of dust is generated by the wind when earth and sand, and coal are piled up on the road or transported in vehicles. Fine dust is scattered by the wind and contaminates the surrounding environment, and is absorbed into the human body through the respiratory system and causes diseases. In order to prevent such problems, conventionally, a canopy or the like has been used to cover the earth and sand, and coal and protect physically them from effects of the wind, or water has been regularly sprayed to suppress generation of dust. However, the method of using a canopy is limited in usable area and economic feasibility. The conventional method of suppressing generation of dust with water to increase a cohesive force between dust particles and increase a weight quickly loses a function of removing dust along with evaporation of the water, and, thus, the water needs to be repeatedly and frequently sprinkled.

Thus, while studying a dust removing material continuously having a long-term dust removing effect, the present inventors found that a dust removing aqueous solution in which cellulose ether is dissolved in water can exhibit a long-term dust removing effect due to water-retention properties and film-forming properties of the cellulose ether, and completed the present invention.

### DISCLOSURE

### Technical Problem

The present invention has been made in an effort to provide an aqueous polymer composition which can exhibit a long-term dust removing effect due to water-retention properties and film-forming properties.

### Technical Solution

An exemplary embodiment of the present invention provides an aqueous polymer composition for removing dust that comprises: cellulose ether; and water.

The cellulose ether is contained in the aqueous polymer composition such that a viscosity of a final cellulose ether aqueous solution for removing dust is in the range of 10 mPa·s to 1,000 mPa·s.

Preferably, the water aqueous polymer composition contains the cellulose ether in an amount of 0.1 to 4 wt. % and the water in an amount of 96 to 99.9 wt. %.

Further, in the aqueous polymer composition for removing dust according to the present invention, there is used the cellulose ether having a viscosity in the range of 50 mPa·s to 60,000 mPa·s based on a Brookfield viscosity of a 2% aqueous solution.

To be specific, preferably, the cellulose ether includes one or more selected from the group consisting of a hydroxy propyl methyl cellulose, a hydroxy ethyl methyl cellulose, a methyl cellulose, and a hydroxy ethyl cellulose.

The aqueous polymer composition for removing dust according to the present invention is spray-injected to a dust generation source.

### Advantageous Effects

According to exemplary embodiments of the present invention, it is possible to obtain the effects as follows.

Firstly, it is possible to exhibit a long-term dust removing function by using a high water-retention property and a film-forming property of a cellulose ether aqueous solution.

Secondly, it is possible to obtain a dust removing material harmless to humans since an eco-friendly cellulose ether is used as a main material.

Thirdly, it is possible to manufacture products with the simple mixing equipment, which is economical.

Fourthly, it is possible to reduce the number of sprinkling water and an amount of water used as compared with a dust removing method by sprinkling general water, which is eco-friendly.

### BEST MODE

Hereinafter, an aqueous polymer composition for removing dust according to an exemplary embodiment of the present invention will be described in detail.

According to an exemplary embodiment of the present invention, an aqueous polymer composition for removing dust includes: cellulose ether; and water.

By spray-injecting an aqueous solution for removing dust in which the cellulose ether as a water soluble polymer according to the present invention is dissolved in the water to a dust generation source, the aqueous polymer composition has a dust removing function for suppressing generation of dust for a long time due to cohesive force between fine dust particles. That is, since the cellulose ether having a water-retention property suppresses evaporation of the water for a long time, a dust removing effect caused by water sprinkling can last for a long time. Further, since a cohesive force between inorganic particles can last due to a film-forming function of the water soluble polymer even after the water is evaporated, the dust removing effect can last.

The cellulose ether as a first component of constituting the aqueous polymer composition for removing dust according to the present exemplary embodiment is a water soluble polymer including a lot of hydroxyl groups (—OH) at molecular chains, and has a high water-retention property which prevents water from being easily evaporated.

Further, when all the water is evaporated, a continuous polymer film is formed. If the aqueous polymer solution having such a property is sprinkled to a fine dust generation source, a fine dust cohesion effect caused by the water can last for a long time, and since a film is formed after drying, a cohesive force between particles can be maintained. Therefore, an excellent dust removing effect can be obtained.

Preferably, the cellulose ether according to the present exemplary embodiment has a viscosity in the range of 50 mPa·s to 60,000 mPa·s, and particularly 100 mPa·s to 30,000 mPa·s based on a Brookfield viscosity of a 2% aqueous solution.

To be specific, examples of the cellulose ether having such a viscosity may include a hydroxy propyl methyl cellulose (HPMC), a hydroxy ethyl methyl cellulose (HEMC), a methyl cellulose (MC), or a hydroxy ethyl cellulose (HEC).

The cellulose ether may be used alone or in combination of two or more.

Preferably, a content of the cellulose ether in the aqueous polymer composition for removing dust according to the present exemplary embodiment may be adjusted depending on a viscosity of the cellulose ether used, and particularly, a final polymer aqueous solution may have a viscosity suitable to be spray-injected. The cellulose ether may have a content such that a viscosity of the final polymer aqueous solution is in the range of 10 mPa·s or more to 1,000 mPa·s or less, and particularly 50 mPa·s or more to 500 mPa·s or less. In this case, the viscosity is determined by a weight mixing ratio of the cellulose ether to the water, and a viscosity of the mixed aqueous solution is based on the Brookfield viscosity.

Meanwhile, the cellulose ether is contained in the aqueous polymer composition in an amount of preferably 0.1 wt. % to 4 wt. %, and more preferably 0.3 wt. % to 2.0 wt. %.

Herein, if the cellulose ether aqueous solution has a viscosity of less than 10 mPa·s, it cannot have a sufficient water-retention property, thereby deteriorating a dust removing function. If the cellulose ether aqueous solution has a viscosity of more than 1,000 mPa·s, when the cellulose ether aqueous solution is injected in a spray type, watering performance of a sprayer is deteriorated, which is not desirable.

Hereinafter, the present invention will be explained in more detail with reference to Examples, but the present invention is not limited thereto.

### EXAMPLE 1

2 wt. % of a hydroxy propyl methyl cellulose having a viscosity of 150 mPa·s based on a Brookfield viscosity of a 2% aqueous solution was dissolved in 98 wt. % of water by using a mechanical mixer so as to prepare a cellulose ether aqueous solution for removing dust as listed in Table 1 below.

### EXAMPLE 2

0.5 wt. % of a hydroxy propyl methyl cellulose having a viscosity of 30,000 mPa·s based on a Brookfield viscosity of a 2% aqueous solution was dissolved in 99.5 wt. % of water by using a mechanical mixer so as to prepare a cellulose ether aqueous solution for removing dust as listed in Table 1 below.

### EXAMPLE 3

1 wt. % of a hydroxy ethyl methyl cellulose having a viscosity of 4,000 mPa·s based on a Brookfield viscosity of a 2% aqueous solution was dissolved in 99 wt. % of water by using a mechanical mixer so as to prepare a cellulose ether aqueous solution for removing dust as listed in Table 1 below.

### EXAMPLE 4

0.3 wt. % of a hydroxy ethyl methyl cellulose having a viscosity of 60,000 mPa·s based on a Brookfield viscosity of a 2% aqueous solution was dissolved in 99.7 wt. % of water by using a mechanical mixer so as to prepare a cellulose ether aqueous solution for removing dust as listed in Table 1 below.

### EXAMPLE 5

1.0 wt. % of a 5:5 mixture of a hydroxy propyl methyl cellulose having a viscosity of 4,000 mPa·s based on a Brookfield viscosity of a 2% aqueous solution and a hydroxy ethyl cellulose was dissolved in 99 wt. % of water by using a mechanical mixer so as to prepare a cellulose ether aqueous solution for removing dust as listed in Table 1 below.

### EXAMPLE 6

0.5 wt. % of a 5:5 mixture of a hydroxy propyl methyl cellulose having a viscosity of 4,000 mPa·s based on a Brookfield viscosity of a 2% aqueous solution and methyl cellulose was dissolved in 99.5 wt. % of water by using a mechanical mixer so as to prepare a cellulose ether aqueous solution for removing dust as listed in Table 1 below.

### COMPARATIVE EXAMPLE 1

An aqueous solution for dust removing as listed in Table 1 below was prepared by using 100 wt. % of water conventionally used.

### COMPARATIVE EXAMPLE 2

5.5 wt. % of a hydroxy propyl methyl cellulose having a viscosity of 4,000 mPa·s based on a Brookfield viscosity of a 2% aqueous solution was dissolved in 94.5 wt. % of water by using a mechanical mixer so as to prepare a cellulose ether aqueous solution for removing dust as listed in Table 1 below.

### COMPARATIVE EXAMPLE 3

0.05 wt. % of a hydroxy propyl methyl cellulose having a viscosity of 4,000 mPa·s based on a Brookfield viscosity of a 2% aqueous solution was dissolved in 99.95 wt. % of water by using a mechanical mixer so as to prepare a cellulose ether aqueous solution for removing dust as listed in Table 1 below.

### COMPARATIVE EXAMPLE 4

2 wt. % of a hydroxy propyl methyl cellulose having a viscosity of 6 mPa·s based on a Brookfield viscosity of a 2% aqueous solution was dissolved in 98 wt. % of water by using a mechanical mixer so as to prepare a cellulose ether aqueous solution for removing dust as listed in Table 1 below.

### COMPARATIVE EXAMPLE 5

1 wt. % of a hydroxy ethyl methyl cellulose having a viscosity of 70,000 mPa·s based on a Brookfield viscosity of a 2% aqueous solution was dissolved in 99 wt. % of water by using a mechanical mixer so as to prepare a cellulose ether aqueous solution for removing dust as listed in Table 1 below.

TABLE 1

| | Cellulose | | | Cellulose ether | |
|---|---|---|---|---|---|
| | ether (CE) used | | | aqueous solution | |
| | Kind | | | Amount of | Amount of |
| | (Substitution | | 2% | CE added | water added |
| | degree*) | | viscosity | (%) | (%) |
| Example 1 | HPMC | (23/8) | 150 | 2.0 | 98 |
| Example 2 | HPMC | (23/8) | 30,000 | 0.5 | 99.5 |
| Example 3 | HEMC | (23/8) | 4,000 | 1.0 | 99 |
| Example 4 | HEMC | (23/8) | 60,000 | 0.3 | 99.7 |
| Example 5 | HPMC + HEC | | 4,000 | 1.0 | 99 |
| Example 6 | HPMC + MC | | 4,000 | 0.5 | 99.5 |
| Comparative | — | | — | 0 | 100 |
| Example 1 | | | | | |
| Comparative | HPMC | (23/8) | 4,000 | 5.5 | 94.5 |
| Example 2 | | | | | |
| Comparative | HPMC | (23/8) | 4,000 | 0.05 | 99.95 |
| Example 3 | | | | | |
| Comparative | HPMC | (23/8) | 6 | 2.0 | 98 |
| Example 4 | | | | | |
| Comparative | HEMC | (23/8) | 70,000 | 1.0 | 99 |
| Example 5 | | | | | |

*Substitution degree: Substitution degree of cellulose ether
DS (Substitution degree of methyl group)/MS (Substitution degree of hydroxy propyl or hydroxy ethyl)

### EVALUATION EXAMPLE

The properties of each of the cellulose ether aqueous solutions for removing dust prepared in Examples 1 to 6 and Comparative Examples 1 to 5 were measured by the method as described below, and the results thereof were as listed in Table 2 below.

1) Measurement of aqueous solution viscosity:

After a dust removing material aqueous solution was left in a constant-temperature water tank at 20° C. for 1 hour, a viscosity of the aqueous solution was measured by using a Brookfield viscometer.

2) Spraying (watering) property:

Watering performance was evaluated by using a spraying machine having a water pressure of 10 bar.

3) Measurement of water-retention property:

After 90 g of each dust removing material aqueous solution was mixed and stirred with 300 g of red clay powder (average particle diameter of 10 micrometer), a water-retention property was measured in accordance with a filter paper method prescribed in KS1593.

4) Measurement of dust removing property (scattering amount):

After scattering red clay powder was piled up to a diameter of 30 cm and a height of 10 cm on a glass plate, 50 g of a dust removing material aqueous solution was sprinkled by using a sprayer for home use. Then, the red clay powder was exposed to a blower having a wind speed of about 10 m/s, and 1 hour later and 3 hours later, a ratio of red clay lost by scattering was measured.

TABLE 2

| | | | | dust removing | |
|---|---|---|---|---|---|
| | | | Water- | property | |
| | | Spraying | retention | 1 hour | 3 hours |
| | Viscosity | performance | property | later | later |
| Example 1 | 150 | ⊚ | 72 | 0 | 5 |
| Example 2 | 300 | ⊚ | 80 | 0 | 5 |
| Example 3 | 400 | ◯ | 85 | 0 | 0 |
| Example 4 | 150 | ⊚ | 75 | 0 | 8 |
| Example 5 | 400 | ◯ | 77 | 0 | 7 |
| Example 6 | 40 | ⊚ | 60 | 0 | 10 |
| Comparative | 0 | ⊚ | 0 | 70 | 100 |
| Example 1 | | | | | |
| Comparative | 60,000 | X | 98 | — | — |
| Example 2 | | | | | |
| Comparative | 4 | ⊚ | 50 | 10 | 30 |
| Example 3 | | | | | |
| Comparative | 6 | ⊚ | 53 | 10 | 30 |
| Example 4 | | | | | |
| Comparative | 7,000 | Δ | 92 | 0 | 0 |
| Example 5 | | | | | |

⊚: Very good,
◯: Normal,
Δ: Poor,
X: Impossible to spray

Referring to Table 2 above, it can be seen that in Examples 1 to 6 where an amount of cellulose ether added was selected appropriately depending on a viscosity of the cellulose ether used, the cellulose ether aqueous solutions had excellent spraying performance together with a high water-retention property and also had an excellent dust removing property.

It can be seen that in Comparative Example 1 where a cellulose ether was not used, Comparative Example 3 where a small amount of cellulose ether was used, and Comparative Example 4 where a cellulose ether having an excessively low viscosity was used, the cellulose ether aqueous solutions had excellent spraying performance but had an inferior water-retention property, resulting in sharp deterioration in dust removing property.

Further, it can be seen that in Comparative Example 2 where a large amount of cellulose ether was used, and Comparative Example 5 where a cellulose ether having an excessively high viscosity was used, the cellulose ether aqueous solutions had a too high viscosity and thus could not be sprayed or had a poor spraying performance, resulting in a decrease in practicality.

While the present invention has been explained with reference to preferable Examples thereof, it will be understood by one of ordinary skill in the art that various changes or equivalent Examples can be made therein. Therefore, the true technical protective scope of the present invention should be determined based on the technical concept of the appended claims.

1. An aqueous polymer composition for removing dust, comprising:
cellulose ether; and
water.

2. The aqueous polymer composition for removing dust of claim 1, wherein the cellulose ether is contained in the polymer composition such that a viscosity of a final cellulose ether aqueous solution for removing dust is in the range of 10 mPa·s to 1,000 mPa·s.

3. The aqueous polymer composition for removing dust of claim 1, wherein the aqueous polymer composition contains the cellulose ether in an amount of 0.1 to 4 wt. % and the water in an amount of 96 to 99.9 wt. %

4. The aqueous polymer composition for removing dust of claim 1, wherein the cellulose ether has a viscosity in the range of 50 mPa·s to 60,000 mPa·s based on a Brookfield viscosity of a 2% aqueous solution.

5. The aqueous polymer composition for removing dust of claim 1, wherein the cellulose ether includes one or more selected from the group consisting of a hydroxy propyl methyl cellulose, a hydroxy ethyl methyl cellulose, methyl cellulose, and a hydroxy ethyl cellulose.

6. The aqueous polymer composition for removing dust of claim 1, wherein the aqueous polymer composition for removing dust is spray-injected to a dust generation source.
